(19) United States
(12) Patent Application Publication
(10) Pub. No.: US 2013/0028635 A1
(43) Pub. Date: Jan. 31, 2013

(54) COVER MEMBER AND CARTRIDGE

(71) Applicants: Naoki Hayashi, Kawasaki-shi (JP); Shigeo Miyabe, Yokohama-shi (JP)

(72) Inventors: Naoki Hayashi, Kawasaki-shi (JP); Shigeo Miyabe, Yokohama-shi (JP)

(73) Assignee: CANON KABUSHIKI KAISHA, Tokyo (JP)

(21) Appl. No.: 13/558,205

(22) Filed: Jul. 25, 2012

(30) Foreign Application Priority Data
Jul. 29, 2011 (JP) 2011-166759

(51) Int. Cl. G03G 15/08

(52) U.S. Cl. 399/119

(57) ABSTRACT

A cover member is mounted on a cartridge including a developer bearing member for providing a developer for developing an electrostatic latent image, and a grip portion to be gripped, and cover an exposed part of the developer bearing member exposed outside a frame member of the cartridge includes a portion configured to partition a space between the grip portion and the exposed part when the cover member is mounted on the cartridge.

### BACKGROUND OF THE INVENTION

1. Field of the Invention

The present disclosure relates to a cartridge removably mounted in a main assembly of an image forming apparatus, and a cover member mounted on the cartridge.

2. Description of the Related Art

In an image forming apparatus, such as a copying machine, printer, and facsimile machine, that uses electrophotographic image-forming process, an electrostatic latent image formed on an image bearing member, such as a photosensitive drum, is developed by a developing unit for visualization as a toner image. In conventionally known image forming apparatuses using such electrophotographic image-forming process, a developing unit formed as a cartridge (a developing cartridge), is removably mounted in a main assembly of the image forming apparatus. Since the developing unit is provided as the cartridge, a user can replace the developing unit.

In some developing cartridges, a developing roller, which carries a developer for developing an electrostatic latent image on an image bearing member, is partially exposed outside a frame of the developing cartridge. Such developing cartridges may be provided with a cover member that covers the exposed part of the developing roller to protect the developing roller during transportation (see Japanese Patent Application Laid-Open No. 2004-264757).

A cover member for covering a developing roller is discussed in Japanese Patent Application Laid-Open No. 2000-019839. In the configuration discussed in Japanese Patent Application Laid-Open No. 2000-019839, a cover has a sealing member made of urethane foam. When the cover member covers an exposed part of a developing roller, space formed between a peripheral portion of the exposed part and the cover member is filled with the sealing member, thereby preventing leaking of a developer from the exposed part into the surrounding area.

During transportation of a developing cartridge, a developer may leak from the inside of the developing cartridge due to physical shock applied to the developing cartridge. Also, at the time of start of using a developing cartridge, friction is generated between a developing roller and a developer supply roller which supplies a developer to the developing roller. To reduce such friction, the developer may be applied in advance to the developing roller and the developer supply roller. The developer may run off the developing roller at an exposed part during transportation of the developing cartridge, and may flow between the developing cartridge and a cover mounted on the developing cartridge, and then to a grip portion of the developing cartridge. The developer adhering to the grip portion can stain the user's hands.

If a sealing member is provided to the cover to surround the peripheral portion of the exposed part of the developing roller as discussed in Japanese Patent Application Laid-Open No. 2000-019839, the number of components is increased.

### SUMMARY OF THE INVENTION

The present disclosure is directed to preventing, with a simple configuration, adhesion of a developer to a grip portion of a cartridge which is provided with a cover for covering a developer bearing member, during transportation of the cartridge.

According to an aspect disclosed herein, a cover is mounted on a cartridge including a developer bearing member for providing a developer for developing an electrostatic latent image, and a grip portion to be gripped and cover an exposed part of the developer bearing member exposed outside a frame member of the cartridge, includes a portion configured to partition a space between the grip portion and the exposed part when the cover is mounted on the cartridge.

According to another aspect of the present invention, a cartridge includes a developer bearing member for providing a developer for developing an electrostatic latent image, and a grip portion to be gripped. A cover member is mounted on the cartridge. The cover member covers an exposed part of the developer bearing member exposed outside a frame member of the cartridge, and includes a portion partitioning a space between the grip portion and the exposed part.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles disclosed herein.

FIG. 1 is a cross-sectional view schematically illustrating a developing cartridge with a cover mounted thereon.

FIG. 2 is a cross-sectional view schematically illustrating an example of an image forming apparatus.

FIG. 3 is a cross-sectional view schematically illustrating an example of the image forming apparatus during image formation.

FIG. 4 is a perspective view illustrating the appearance of the developing cartridge.

FIGS. 5A and 5B are cross-sectional views schematically illustrating the developing cartridge.

FIGS. 6A, 6B, and 6C schematically illustrate a developing roller and a toner supply roller.

FIGS. 7A and 7B schematically illustrate the developing cartridge and the cover.

FIG. 8 is a perspective view schematically illustrating the cover.

FIG. 9 is an enlarged cross-sectional view schematically illustrating a grip portion of the developing cartridge.

### DESCRIPTION OF THE EMBODIMENTS

Various exemplary embodiments, features, and aspects will be described in detail below with reference to the drawings.

Referring to the drawings, exemplary embodiments of the present disclosure will be described in detail below with reference to a so-called rotary-type color image forming apparatus that includes a rotary in which a plurality of developing cartridges can be mounted.

### <Entire Configuration of Image Forming Apparatus>

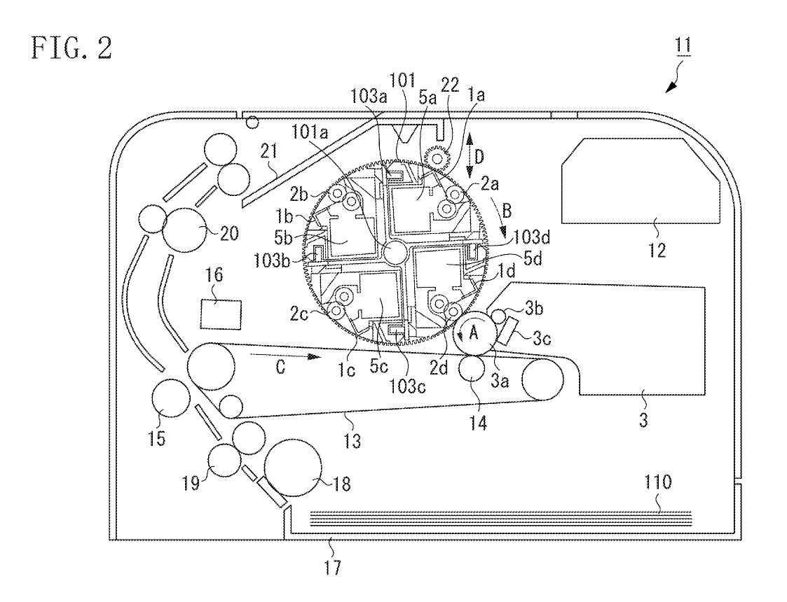

First, image-forming operation of the image forming apparatus will be described with reference to FIG. 2. The image forming apparatus 11 according to an exemplary embodiment of the present disclosure is a full-color (four-color) laser-beam printer. FIG. 2 is a cross-sectional view schematically illustrating the configuration of the image forming apparatus 11.

As illustrated in FIG. 2, the image forming apparatus 11 includes a photosensitive drum 3a serving as an image bearing member. A charging unit 3b, an exposure unit 12, a developing unit, and a cleaning unit 3c are disposed around the photosensitive drum 3a. The charging unit 3b uniformly charges the photosensitive drum 3a. The exposure unit 12 applies a laser beam onto the photosensitive drum 3a to form an electrostatic latent image. The developing unit develops the electrostatic latent image formed on the photosensitive drum 3a. The cleaning unit 3c removes residual toner on the photosensitive drum 3a.

The developing unit according to the present exemplary embodiment is composed of a yellow developing cartridge 5a, a magenta developing cartridge 5b, a cyan developing cartridge 5c, and a black developing cartridge 5d. The developing cartridges 5a, 5b, 5c, and 5d are each used to develop and visualize an electrostatic latent image on the photosensitive drum 3a with a developer (toner) of a corresponding color. The developing cartridges 5a, 5b, 5c, and 5d are removably mounted in a main assembly of the image forming apparatus 11 (an image forming apparatus main assembly). The developing cartridges 5a, 5b, 5c, and 5d include developing rollers 2a, 2b, 2c, and 2d, respectively. The developing rollers 2a, 2b, 2c, and 2d serve as developer bearing members for carrying the respective developers. The developing cartridges 5a, 5b, 5c, and 5d are held by a rotary 101 which is rotatably mounted in the main assembly of the image forming apparatus 11.

In the present exemplary embodiment, the photosensitive drum 3a, the charging unit 3b, and the cleaning unit 3c integrally form a drum cartridge 3. The drum cartridge 3 is removably mounted in the main assembly of the image forming apparatus 11.

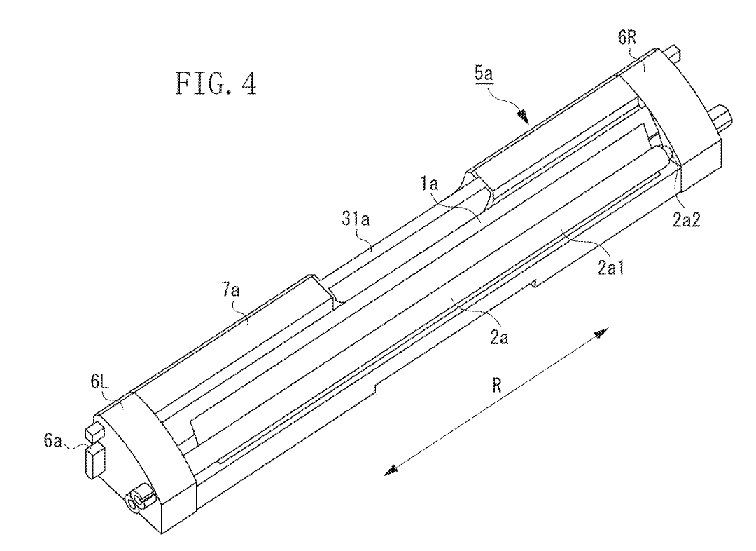

Next, a configuration in which the rotary 101 holds each developing cartridge will be described. As illustrated in FIG. 4, the yellow developing cartridge 5a is provided with a portion 6a to be locked. As illustrated in FIG. 2, the rotary 101 is provided with a developing cartridge locking member 103a. The locked portion 6a of the yellow developing cartridge 5a engages with the developing cartridge locking member 103a. This engagement restricts movement of the yellow developing cartridge 5a in the directions indicated by an arrow D illustrated in FIG. 2, so that the yellow developing cartridge 5a is supported by the rotary 101. The magenta developing cartridge 5b, the cyan developing cartridge 5c, and the black developing cartridge 5d have the same configuration as the yellow developing cartridge 5a, and are supported by the rotary 101 in the same manner as the yellow developing cartridge 5a.

Image formation operation will be described below. First, the photosensitive drum 3a is rotated in the direction of an arrow A illustrated in FIG. 2. In synchronization with the rotation of the photosensitive drum 3a, an intermediate transfer belt 13 is rotated in the direction of an arrow C illustrated in FIG. 2. The surface of the photosensitive drum 3a is then uniformly charged by the charging unit 3b, while exposed to light applied by the exposure unit 12, thereby forming an electrostatic latent image on the photosensitive drum 3a.

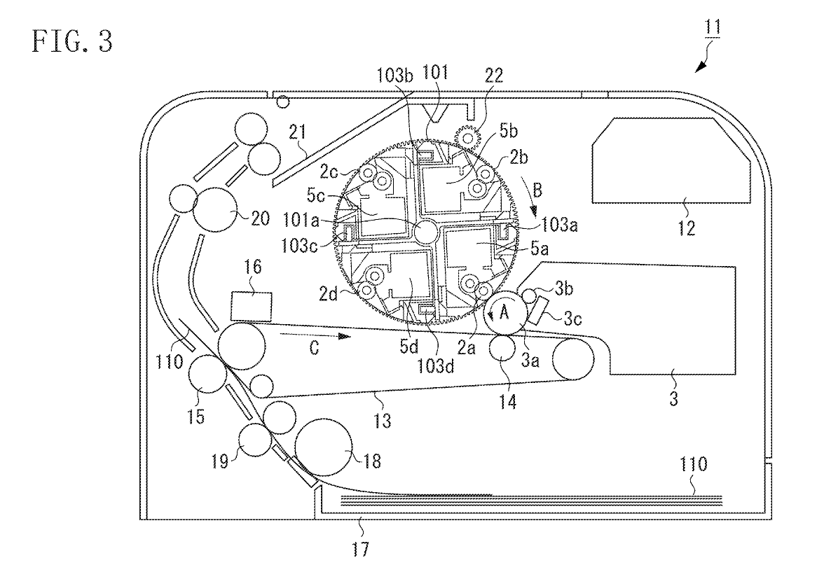

Upon the formation of the electrostatic latent image, a drive transmission mechanism 22 disposed in the image forming apparatus 11 causes the rotary 101 to rotate about a rotary rotating shaft 101a in the direction of an arrow B illustrated in FIG. 2. As illustrated in FIG. 3, as a result of the rotation of the rotary 101, the yellow developing cartridge 5a is located in a development position facing the photosensitive drum 3a.

The image forming apparatus 11 then generates a potential difference between the photosensitive drum 3a and the developing roller 2a so that the yellow toner adheres to the electrostatic latent image formed on the photosensitive drum 3a. The yellow toner thus adheres to the electrostatic latent image formed on the photosensitive drum 3a, thereby developing the electrostatic latent image. In other words, a yellow toner image is formed on the photosensitive drum 3a.

The image forming apparatus 11 then applies a voltage, which is opposite in polarity to the polarity of the toner, to a primary transfer roller 14 disposed on the inner side of the intermediate transfer belt 13. Consequently, the yellow toner image on the photosensitive drum 3a is primarily transferred onto the intermediate transfer belt 13.

When the primary transfer of the yellow toner image is completed in this manner, the rotary 101 is driven by the drive transmission mechanism 22 to rotate further in the direction of the arrow B. With this rotational movement of the rotary 101, the magenta developing cartridge 5b, the cyan developing cartridge 5c, and the black developing cartridge 5d are sequentially placed in the development position facing the photosensitive drum 3a. For each of these colors, magenta, cyan, and black, the formation, development, and primary transfer of an electrostatic latent image are performed in sequence as in the case of yellow. The resultant toner images of the four colors are superimposed on the intermediate transfer belt 13.

As illustrated in FIG. 2, during this process, a secondary transfer roller 15 is not in contact with the intermediate transfer belt 13. A cleaning unit 16 for the intermediate transfer belt 13 is also in a position where the cleaning unit 16 does not contact the intermediate transfer belt 13.

A stack of sheets of paper 110 as recording media is accommodated in a sheet feeding cassette 17 in a lower portion of the image forming apparatus 11. Each sheet of paper 110 is picked up from the sheet feeding cassette 17 and fed to conveyance rollers 19 by a sheet feeding roller 18. The conveyance rollers 19 feed the sheet of paper 110 to a space between the intermediate transfer belt 13 and the secondary transfer roller 15. At this time, as illustrated in FIG. 3, the secondary transfer roller 15 is pressed into contact with the intermediate transfer belt 13.

Furthermore, a voltage of a polarity opposite to that of the toner is applied to the secondary transfer roller 15, so that the toner images of the four colors superimposed on the intermediate transfer belt 13 are secondarily transferred onto the surface of the conveyed sheet of paper 110.

The sheet of paper 110 with the toner images transferred thereon is advanced to a fixing device 20. In the fixing device 20, the sheet of paper 110 is subjected to heat and pressure, so that the toner images are fixed on the sheet of paper 110. The sheet of paper 110 is then ejected from the fixing device 20 into a sheet discharge unit 21 external to the image forming apparatus 11. In this manner, the image is formed on the sheet of paper 110.

### <Description of Developing Cartridge>

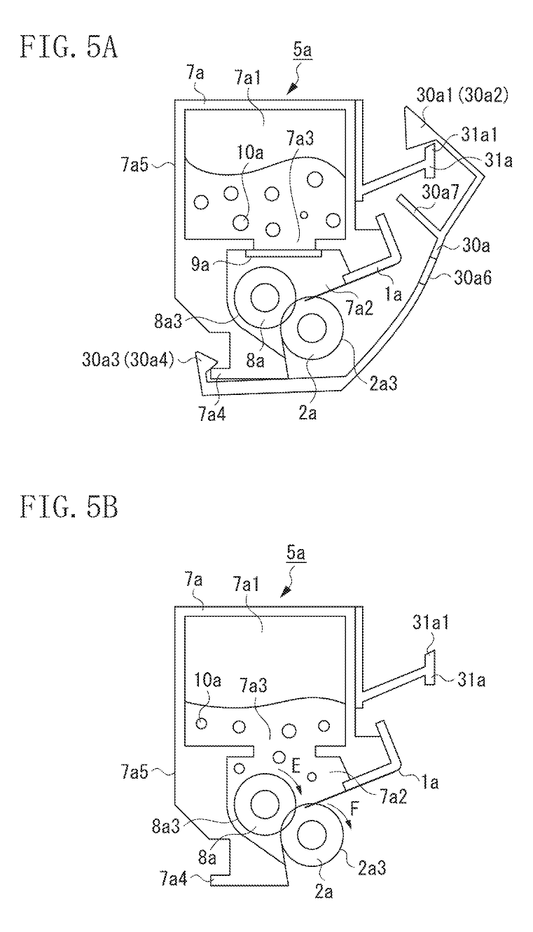

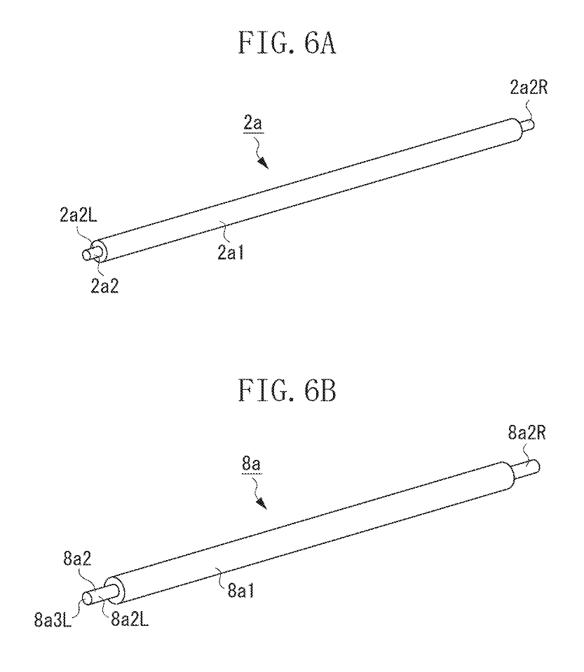

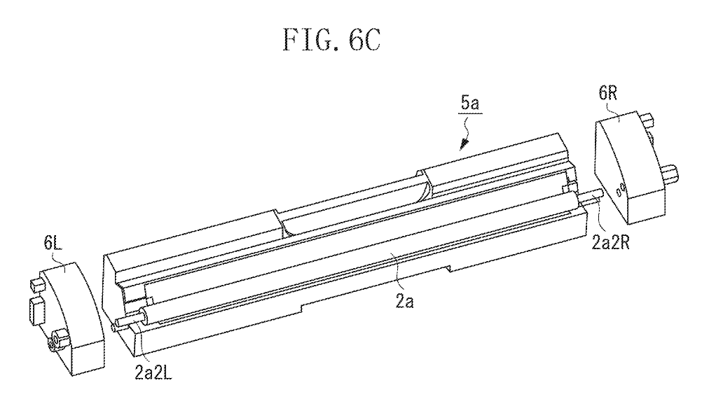

The yellow developing cartridge 5a, the magenta developing cartridge 5b, the cyan developing cartridge 5c, and the black developing cartridge 5d all have the same configuration. Hence, referring to FIGS. 5A, 5B, 6A, 6B, and 6C, the configuration of the developing cartridges according to the present exemplary embodiment will be described with reference to the yellow developing cartridge 5a as a representative example. The yellow developing cartridge 5a will be hereinafter referred to simply as the cartridge 5a.

FIGS. 5A and 5B are cross-sectional views illustrating the cartridge 5a. The cross-sectional views in FIGS. 5A and 5B are perpendicular to the rotational axis of the developing roller 2a, and pass through approximately the center of the cartridge 5a in the longitudinal direction (i.e., the direction along the rotational axis) of the developing roller 2a. FIG. 6A schematically illustrates the developing roller 2a according to the present exemplary embodiment. FIG. 6B schematically illustrates a toner supply roller 8a according to the present exemplary embodiment. FIG. 6C schematically illustrates the cartridge 5a supporting the developing roller 2a.

In the following description, the longitudinal direction of the developing roller 2a may be referred to simply as the longitudinal direction.

As illustrated in FIG. 6A, the developing roller 2a serving as a developer bearing member is composed of a rubber roller portion 2a1 and a rigid shaft 2a2. The rigid shaft 2a2 passes through the rubber roller portion 2a1 in a direction along the rotational axis of the developing roller 2a. Both ends of the rigid shaft 2a2 form projection portions 2a2L and 2a2R that protrude from the rubber roller portion 2a1.

The toner supply roller 8a is a developer supply member which supplies a developer (toner) to the developing roller 2a. As illustrated in FIG. 6B, the toner supply roller 8a is composed of a sponge roller portion 8a1 and a rigid shaft 8a2. The rigid shaft 8a2 passes through the sponge roller portion 8a1 in a direction along the rotational axis of the toner supply roller 8a. Both ends of the rigid shaft 8a2 form projection portions 8a2L and 8a2R that protrude from the sponge roller portion 8a1.

As illustrated in FIG. 6C, the developing cartridge 5a holds the projection portions 2a2L and 2a2R of the developing roller 2a with respective side members 6L and 6R in such a manner as to allow rotation of the developing roller 2a and the toner supply roller 8a.

A developer container 7a which is a frame member of the cartridge 5a, is divided into a toner container 7a1, which accommodates a toner, and a development chamber 7a2, which supports the developing roller 2a and the toner supply roller 8a. The toner container 7a1 and the development chamber 7a2 are connected through a toner supply opening 7a3.

A rubber roller outer circumferential surface 2a3 of the developing roller 2a is partially exposed outside the developer container 7a. Thus, a user may touch the exposed part with hands. To avoid this, while the cartridge 5a is unused until it reaches the user, a cover 30a for covering the entire exposed part of the developing roller 2a is provided on the cartridge 5a as illustrated in FIG. 5A. The cover 30a is removed from the cartridge 5a when the cartridge 5a is mounted in the main assembly of the image forming apparatus 11. As illustrated in FIG. 3, when the developing cartridge 5a is mounted, the rubber roller outer circumferential surface 2a3 of the developing roller 2a contacts the photosensitive drum 3a.

As illustrated in FIG. 5A, in the present exemplary embodiment, while the cartridge 5a is unused, a toner seal 9a in the form of a film is fixed to the developer container 7a at the toner supply opening 7a3 to separate the toner container 7a1 and the development chamber 7a2 by heat-welding or the like. As illustrated in FIG. 5B, the toner seal 9a is removed prior to use and toner 10a within the toner container 7a1 is supplied into the development chamber 7a2.

In the cartridge 5a, the sponge roller portion 8a1 of the toner supply roller 8a is compressed against the developing roller 2a and deformed. To be specific, the sponge roller portion 8a1 of the toner supply roller 8a is in contact with the rubber roller portion 2a1 of the developing roller 2a with a certain deformation relative to a toner supply roller outer circumferential surface 8a3. The toner supply roller 8a and the developing roller 2a rotate respectively in the directions of arrows E and F illustrated in FIG. 5B maintaining a certain contact pressure therebetween.

Even if the toner seal 9a is removed to use the cartridge 5a, the toner 10a accommodated in the toner container 7a does not immediately move to flow between the developing roller 2a and the toner supply roller 8a. If the developing cartridge 5a is used in this state, the developing roller 2a and the toner supply roller 8a will rotate in opposite directions, in other words, the surfaces thereof will move in the opposite directions, to frictionally slide against each other. Consequently, the friction load may be increased to cause a rupture of the sponge roller portion 8a1 of the toner supply roller 8a. To avoid this, toner is applied in advance to the developing roller 2a and the toner supply roller 8a to reduce the friction load. The toner is desirably applied to both the developing roller 2a and the toner supply roller 8a. Alternatively, the toner may be applied to either the developing roller 2a or the toner supply roller 8a.

When the toner 10a in the development chamber 7a2 is supplied to the toner supply roller 8a, the toner supply roller 8a rotates to supply the toner 10a to the developing roller 2a. Then, a thin layer of the toner 10a is formed on the developing roller 2a by a developing blade 1a which is in contact with the developing roller 2a. In the present exemplary embodiment, the developing blade 1a is a developer regulating member which controls the layer thickness of the toner carried by the developing roller 2a. In the present exemplary embodiment, the developing blade 1a is composed of a sheet member made of metal which contacts the developing roller 2a, and a plate (a fixing member) which supports and secures the sheet member to the developer container 7a. The toner is then developed in a position where the developing roller 2a faces the photosensitive drum 3a. After that, the toner supply roller 8a removes the residual toner 10a remaining on the developing roller 2a, while supplying new toner. At this time, the main body of the image forming apparatus 11 supplies a voltage to the developing roller 2a to generate a potential difference between the developing roller 2a and the photosensitive drum 3a. The main body of the image forming apparatus 11 also supplies a voltage to the toner supply roller 8a.

### <Configuration of Cover Member>

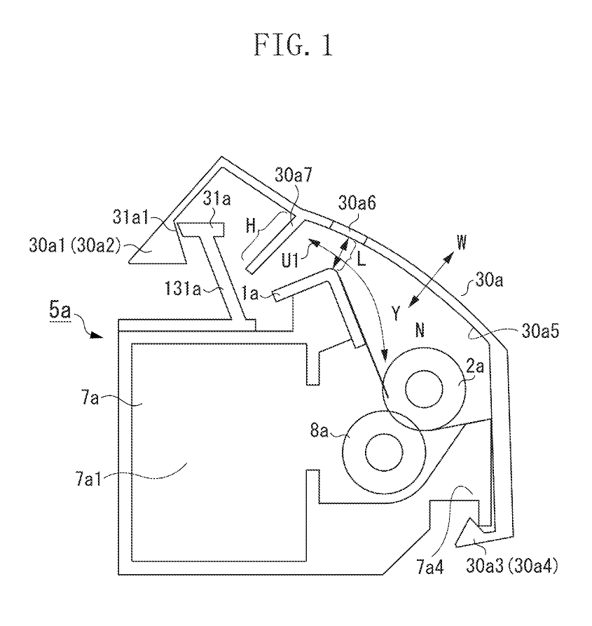

A configuration in which the cover 30a engages with the cartridge 5a will be described with reference to FIGS. 1, 7, 8, and 9.

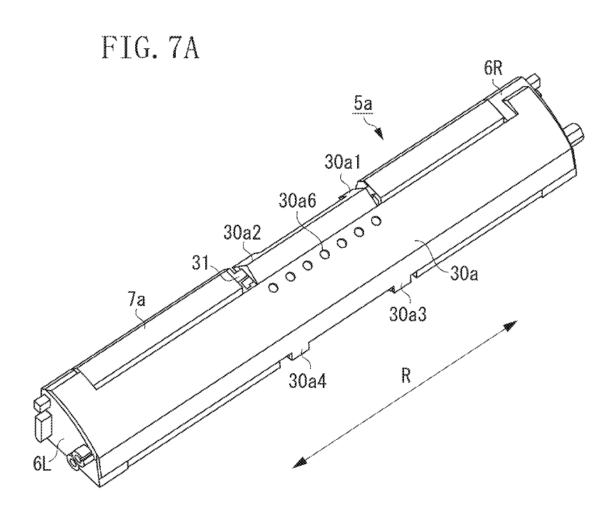

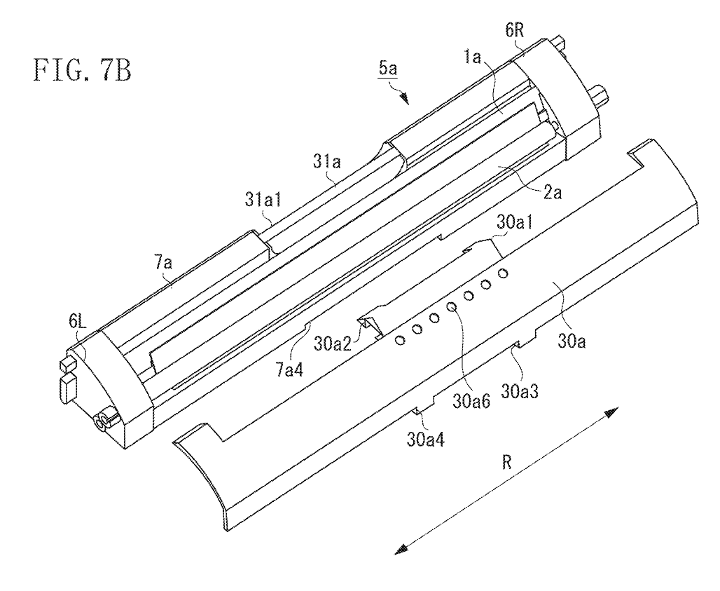

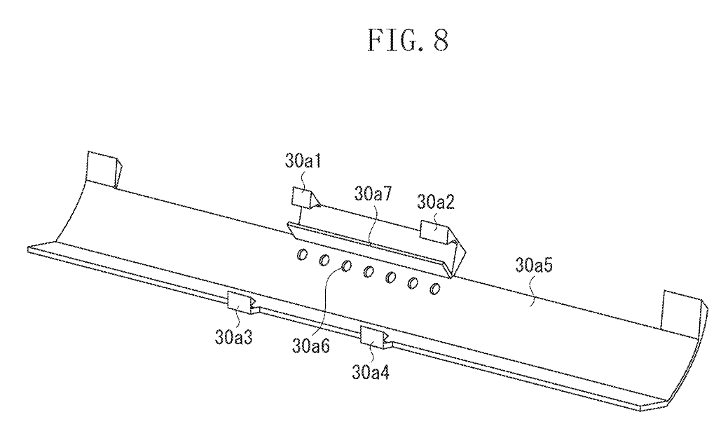

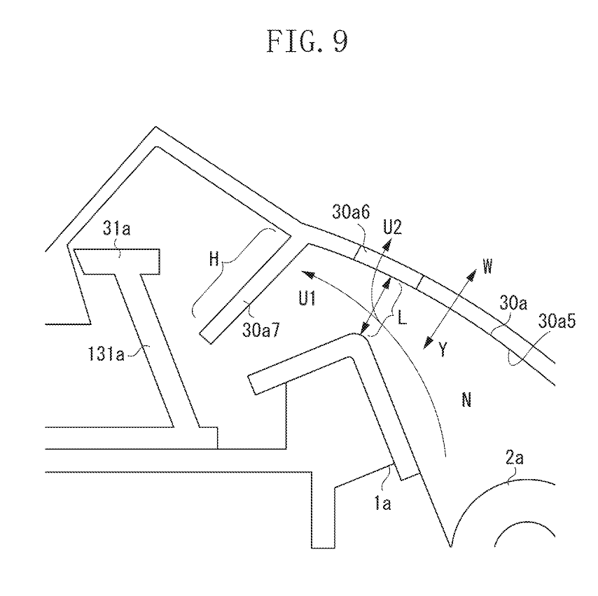

FIG. 1 is a cross-sectional view passing through approximately the center of the cartridge 5a in the longitudinal direction (i.e., the direction indicated by an arrow R illustrated in FIG. 7A), and perpendicular to the longitudinal direction. A grip portion 31a is provided in a central region of the developer container 7a in the longitudinal direction. The grip portion 31a, which is a projection in the shape of a wall surface extending in the longitudinal direction, is used by a user to grasp the developing cartridge 5a. FIG. 7A is a perspective view illustrating the cartridge 5a with the cover 30a mounted thereon. FIG. 7B is a perspective view illustrating the developing cartridge 5a with the cover 30a removed therefrom. FIG. 8 is a perspective view schematically illustrating the cover 30a. FIG. 9 is an enlarged view illustrating a part of the cartridge 5a in the vicinity of the grip portion 31a.

As illustrated in FIG. 7B, the cover 30a engages with the cartridge 5a at four engaging portions 30a1, 30a2, 30a3, and 30a4, which are provided in the vicinity of the center of the cover 30a in the longitudinal direction. When the cover 30a goes into engagement with the cartridge 5a, the engaging portions 30a1 and 30a2 of the cover 30a engage with a portion to be engaged 31a1 on the grip portion 31a. The engaging portions 30a3 and 30a4 engage with a portion 7a4 to be engaged on the developer container 7a. As illustrated in FIG. 7A, with this engagement, the cover 30a is mounted on the cartridge 5a to cover and protect the exposed part of the developing roller 2a. When mounted, the cover 30a covers the grip portion 31a.

The configuration of the cover 30a will be described with reference to FIGS. 1 and 7A. As illustrated in FIGS. 1, 7A, and 8, the cover 30a has vent holes 30a6. The vent holes 30a6 are openings passing though the cover 30a. The vent holes 30a6 are located where the distance between an inner surface 30a5 of the cover 30a and the developing blade 1a is the shortest when the cover 30a is mounted on the developing cartridge 5a. In the present exemplary embodiment, the vent holes 30a6 are positioned to face the developing blade 1a at a distance L. The multiple vent holes 30a6 are arranged in the longitudinal direction in an area whose length substantially corresponds to the longitudinal dimension of the grip portion 31a.

If a strong physical shock is applied to the cartridge 5a during transportation, the toner applied to the developing roller 2a and the toner supply roller 8a may be scattered into space N illustrated in FIG. 1 from the exposed part of the developing roller 2a and from a gap between the developing blade 1a and the developing roller 2a. The space N is space sandwiched by the inner surface 30a5 of the cover 30a and the cartridge 5a. At this time, the cover 30a mounted on the cartridge 5a may also undergo the shock, and the inner surface 30a5 facing the cartridge 5a may move in the directions of arrows Y and W in FIG. 9 relative to the cartridge 5a. If the inner surface 30a5 moves in the direction of the arrow W, the space N is increased. In this situation, if the inner surface 30a5 moves in the direction of the arrow Y, the space N is significantly reduced in size. The significant size reduction causes atmospheric pressure to increase in the space N. Consequently, the scattered toner, together with the air, is forced out of the space N. To be specific, the scattered toner moves, together with the air, in the direction from the exposed part of the developing roller 2a toward the grip portion 31a (i.e., the direction indicated by an arrow U1 illustrated in FIG. 1).

In the present exemplary embodiment, however, the vent holes 30a6 passing through the cover 30a are positioned between the exposed part of the developing roller 2a and the grip portion 31a in the toner moving direction U1. This allows the toner-conveying air to escape through the vent holes 30a6 to the outside of the cover 30a, more specifically, in the direction indicated by an arrow U2 illustrated in FIG. 9, thereby preventing the toner from moving to the grip portion 31a.

In particular, in the present exemplary embodiment, the vent holes 30a6 are located where the distance between the inner surface 30a5 of the cover 30a and the developing blade 1a is the shortest. This causes atmospheric pressure to increase in the vicinity of the vent holes 30a6. The increased atmospheric pressure encourages the escape of the air to the outside of the cover 30a through the vent holes 30a6, thereby enabling the toner to be easily expelled, together with the air, to the outside of the cover 30a.

In addition, as illustrated in FIGS. 1 and 9, the cover 30a is provided with a projection portion (hereinafter referred to as a rib wall) 30a7 in the shape of a wall surface protruding in a direction toward the cartridge 5a and extending in the longitudinal direction. The rib wall 30a7 is located farther away from the exposed part of the developing roller 2a and closer to the grip portion 31a than the vent holes 30a6 in a toner scattering path U. The rib wall 30a7 is positioned so as to block the path between the developing roller 2a and the grip portion 31a when the cover 30a is mounted on the cartridge 5a. More specifically, the rib wall 30a serves as a partitioning portion between the exposed part of the developing roller 2a and the grip portion 31a. The rib wall 30a7 protrudes in the direction toward the developing cartridge 5a, which prevents movement, toward the grip portion 31a, of the toner that has not been expelled through the vent holes 30a6. In other words, the rib wall 30a7 prevents adhesion of the toner to the grip portion 31a.

In the present exemplary embodiment, the longitudinal dimension of the rib wall 30a7 is substantially equal to that of the grip portion 31a so as to prevent adhesion of the toner to the grip portion 31a more reliably. However, the longitudinal dimension of the rib wall 30a7 may be longer than that of the grip portion 31a, so long as the rib wall 30a7 does not interfere with the developer container 7a when the cover 30a is mounted on the developing cartridge 5a.

Furthermore, the height H of the rib wall 30a7 is set to be greater than the distance L between the vent holes 30a6 and the developing blade 1a when the cover 30a is mounted on the developing cartridge 5a. The rib wall 30a7 having such a height greater than the distance between the vent holes 30a6 and the cartridge 5a can more easily block the toner that has not been expelled through the vent holes 30a6, and thus can more easily prevent the movement of the toner to the grip portion 31a.

In the present exemplary embodiment, the rib wall 30a7 is located in a position protruding toward the developing blade 1a supported by the developer container 7a. However, the rib wall 30a7 may be located in any other position, so long as the rib wall 30a7 protrudes toward the developing cartridge 5a to serve as a barrier between the exposed part of the developing roller 2a and the developing blade 1a. Specifically, the rib wall 30a7 may be configured to protrude toward the developer container 7a or any member, other than the developing blade 1a, that is supported by the developer container 7a. In that case, the height of the rib wall 30a7 may also be greater than the distance between the vent holes 30a and the cartridge 5a, in other words, the shortest distance between the vent holes 30a and the developer container 7a or the member supported by the developer container 7a.

In summary, in the present exemplary embodiment, the cover 30a that covers the exposed part of the developing roller 2a serving as a developer bearing member is removably mounted on the cartridge 5a. The cover 30a is provided with a partitioning portion (the rib wall 30a7) that protrudes in the direction toward the cartridge 5a to partition the space between the grip portion 31a and the exposed part of the developing roller 2a. The cover 30a is also provided with openings (the vent holes 30a6) passing through the cover 30a and located between the rib wall 30a7 and the exposed part of the developing roller 2a. The cover 30a blocks the flow of toner-conveying air with the rib wall 30a7, and then causes that air to escape to the outside through the vent holes 30a6, thereby preventing the movement of the toner to the grip portion 31a. This prevents adhesion of the toner scattered from the inside of the cartridge 5a or from the exposed part of the developing roller 2a to the grip portion 31a due to physical shock during transportation of the cartridge 5a.

In the present exemplary embodiment, the cover 30a is shaped to cover the grip portion 31a of the cartridge 5a. Since the toner moving path is formed extending from the exposed part of the developing roller 2a to the grip portion 31a between the cartridge 5a and the cover 30a, blocking the toner moving path with the configuration described above is particularly effective. However, even when the grip portion 31a is exposed outside the cover 30a, toner may be conveyed to the grip portion 31a due to a flow of toner-conveying air generated between the cartridge 5a and the cover 30a. Therefore, blocking the toner moving path by employing the above-described configuration is effective.

Furthermore, according to the present exemplary embodiment, the grip portion 31a need not be located away from the developing roller 2a to prevent adhesion of toner. Thus, the size of the cartridge 5a can be reduced by positioning the grip portion 31a and the developing roller 2a close to each other.

In the foregoing exemplary embodiment, a rotary-type image forming apparatus which uses a developing cartridge for color printing has been described. However, the present invention is not limited to this embodiment, but may be applied to developing cartridges used in inline-type image forming apparatuses and to developing cartridges for monochromatic printing. The embodiments disclosed herein may also be applied to process cartridges which include an image bearing member and a developer bearing member.

While the present disclosure has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-166759 filed Jul. 29, 2011, which is hereby incorporated by reference herein in its entirety.

What is claimed is:

1. A cover member mounted on a cartridge including a developer bearing member for providing a developer for developing an electrostatic latent image, and a grip portion to be gripped and cover an exposed part of the developer bearing member exposed outside a frame member of the cartridge, the cover member comprising:
a partitioning portion configured to partition a space between the grip portion and the exposed part when the cover member is mounted on the cartridge.

2. The cover member according to claim 1, further comprising an opening portion configured to be located between the partitioning portion and the exposed part when the cover member is mounted on the cartridge, and configured to pass through the cover member.

3. The cover member according to claim 2, wherein a height of the partitioning portion is greater than a distance from the opening portion to the cartridge when the cover member is mounted on the cartridge.

4. The cover member according to claim 2, further comprising a plurality of openings as the opening portion, arranged in a longitudinal direction of the developer bearing member.

5. The cover member according to claim 1, wherein the partitioning portion extends in a longitudinal direction of the developer bearing member.

6. The cover member according to claim 1, wherein the cover member covers the grip portion when the cover member is mounted on the cartridge.

7. The cover member according to claim 1, further comprising an engaging portion configured to engage with the grip portion.

8. The cover member according to claim 1, wherein the partitioning portion protrudes from the cover member in a direction toward the cartridge.

9. A cartridge comprising a developer bearing member for providing a developer for developing an electrostatic latent image, and a grip portion to be gripped,
wherein a cover member is mounted on the cartridge, covering an exposed part of the developer bearing member exposed outside a frame member of the cartridge, and includes a portion partitioning a space between the grip portion and the exposed part.

10. The cartridge according to claim 9, wherein the cover member includes an opening portion located between the partitioning portion and the exposed part, and configured to pass through the cover member.

11. The cartridge according to claim 10, wherein a height of the partitioning portion is greater than a distance from the opening portion to the cartridge.

12. The cartridge according to claim 10, wherein the cover member includes a plurality of openings as the opening portion, arranged in a longitudinal direction of the developer bearing member.

13. The cartridge according to claim 9, wherein the developer is applied to the developer bearing member when the cartridge is unused.

14. The cartridge according to claim 9, further comprising a developer supply member configured to contact the developer bearing member and supply the developer to the developer bearing member,
wherein the developer is applied to at least either the developer bearing member or the developer supply member when the cartridge is unused.

15. The cartridge according to claim 9, wherein the partitioning portion extends in a longitudinal direction of the developer bearing member.

16. The cartridge according to claim 9, wherein the cover member covers the grip portion.

17. The cartridge according to claim 9, wherein the cover member includes an engaging portion configured to engage with the grip portion.

18. The cartridge according to claim 9, wherein the partitioning portion protrudes from the cover member in a direction toward the cartridge.

19. The cartridge according to claim 18, further comprising a developer regulating member configured to regulate a layer thickness of the developer carried by the developer bearing member,
wherein the partitioning portion protrudes in a direction toward the developer regulating member.
